(19) United States
(12) Patent Application Publication
(10) Pub. No.: US 2025/0207778 A1
(43) Pub. Date: Jun. 26, 2025

(54) COMBUSTOR AND GAS TURBINE

(71) Applicant: MITSUBISHI HEAVY INDUSTRIES, LTD., Tokyo (JP)

(72) Inventors: Keisuke MIURA, Tokyo (JP); Shinichi FUKUBA, Tokyo (JP); Kiyoshi FUJIMOTO, Tokyo (JP); Kenta TANIGUCHI, Tokyo (JP); Tomo KAWAKAMI, Tokyo (JP); Taku EGAWA, Tokyo (JP); Zhi ZHANG, Tokyo (JP)

(21) Appl. No.: 18/848,644

(22) PCT Filed: Mar. 8, 2023
(86) PCT No.: PCT/JP2023/008733

§ 371 Date: Sep. 19, 2024

(30) Foreign Application Priority Data
Mar. 30, 2022 (JP) 2022-056957

(51) Int. Cl. F23R 3/20; F23R 3/18; F23R 3/28; F23R 3/42

(52) U.S. Cl. CPC F23R 3/20; F23R 3/18; F23R 3/28; F23R 3/42

(57) ABSTRACT

A combustor of the present disclosure comprises: a combustor plate that includes an upstream end surface and a downstream end surface which are orthogonal to a combustor axis; a plurality of mixing tubes which extend across the upstream end surface and the downstream end surface so as to penetrate said surfaces, and into which air is introduced from the upstream end surface side; a bump section that is formed so as to rise from the inner wall surface of the mixing tubes and that has a streamlined shape in a radial view of the mixing tubes; and a fuel injection hole having an opening that is open to the bump section to enable fuel to be injected into the mixing tubes.

### TECHNICAL FIELD

The present disclosure relates to a combustor and a gas turbine.

Priority is claimed on Japanese Patent Application No. 2022-56957 filed on Mar. 30, 2022, the content of which is incorporated herein by reference.

### BACKGROUND ART

For example, PTL 1 discloses a cluster combustor that is an example of a combustor used in a gas turbine.

The cluster combustor includes a plurality of mixing tubes which are aligned and into which air is introduced, and a fuel supply section which injects fuel from inner wall surfaces of the mixing tubes. With the injection of the fuel, a mixed gas of the air and the fuel flows in the mixing tubes and is jetted to a downstream side. At this time, as the mixed gas is ignited, a plurality of small-scale flames are formed at an outlet of each of the mixing tubes.

The cluster combustor is provided with a columnar protrusion that protrudes from the inner wall surface of the mixing tube, and the fuel supply section is configured to supply the fuel from a top section of the protrusion. A flow of the air flowing inside the mixing tube is disturbed by the protrusion, so that mixing of the air and the fuel is promoted.

### CITATION LIST

### Patent Literature

[PTL 1] US Unexamined Patent Application Publication No. 2013/0232989 Specification

### SUMMARY OF INVENTION

### Technical Problem

In the combustor as described above, the fuel injected into the mixing tube and the air flowing inside the mixing tube interfere with each other, so that a twin vortex occurs around a jet of the fuel and the columnar protrusion. In a case where the fuel is diffused by the twin vortex, a fuel concentration of the mixing tube on an inner wall surface side may be high. Accordingly, there is a concern that flashback in which a flame enters the mixing tube may occur.

The present disclosure is made to solve the above-described problem, and an object of the present disclosure is to provide a combustor and a gas turbine which can prevent flashback.

### Solution to Problem

In order to solve the above problem, a combustor according to the present disclosure includes a combustor plate including an upstream end surface and a downstream end surface which are orthogonal to a combustor axis, a plurality of mixing tubes which extend to penetrate across the upstream end surface and the downstream end surface and into which air is introduced from an upstream end surface side, a bump section which is formed to rise from an inner wall surface of the mixing tube and which has a streamlined shape extending in a direction of a central axis of the mixing tube when viewed in a radial direction of the mixing tube, and a fuel injection hole which has an opening section, which is open in the bump section and through which fuel is injectable into the mixing tube.

A gas turbine according to the present disclosure includes a compressor that generates air, the above-described combustor that generates a combustion gas by combusting a mixed gas generated by mixing fuel with the air compressed by the compressor, and a turbine that is driven with the combustion gas.

### Advantageous Effects of Invention

With a combustor and a gas turbine of the present disclosure, flashback can be prevented.

### BRIEF DESCRIPTION OF DRAWINGS

FIG. 1 is a schematic view showing a schematic configuration of a gas turbine according to a first embodiment of the present disclosure.

FIG. 2 is a longitudinal sectional view showing a schematic configuration of a combustor according to the first embodiment of the present disclosure.

FIG. 3 is a longitudinal sectional view of a mixing tube of a combustor plate of the combustor according to the first embodiment of the present disclosure.

FIG. 4 is a sectional view taken along line IV-IV of FIG. 3 and is a view of a bump section of the combustor plate of the combustor according to the first embodiment of the present disclosure when viewed from a radial inner side of the mixing tube.

FIG. 5 is a sectional view orthogonal to a central axis of the mixing tube of the combustor plate of the combustor according to the first embodiment of the present disclosure.

FIG. 6 is a view showing effects of operation of the combustor according to the first embodiment of the present disclosure.

FIG. 7 is a view of a bump section of a combustor plate of a combustor according to a second embodiment of the present disclosure when viewed from a radial inner side of a mixing tube.

FIG. 8 is a view of a bump section of a combustor plate of a combustor according to a third embodiment of the present disclosure when viewed from a radial inner side of a mixing tube.

FIG. 9 is a longitudinal sectional view of a mixing tube of a combustor plate of a combustor according to a fourth embodiment of the present disclosure.

FIG. 10 is a longitudinal sectional view of a mixing tube of a combustor plate of a combustor according to a fifth embodiment of the present disclosure.

FIG. 11 is a sectional view orthogonal to a central axis of a mixing tube of a combustor plate of a combustor according to a sixth embodiment of the present disclosure.

FIG. 12 is a view of a bump section of a combustor plate of the combustor according to the seventh embodiment of the present disclosure when viewed from a radial inner side of the mixing tube.

### DESCRIPTION OF EMBODIMENTS

### First Embodiment

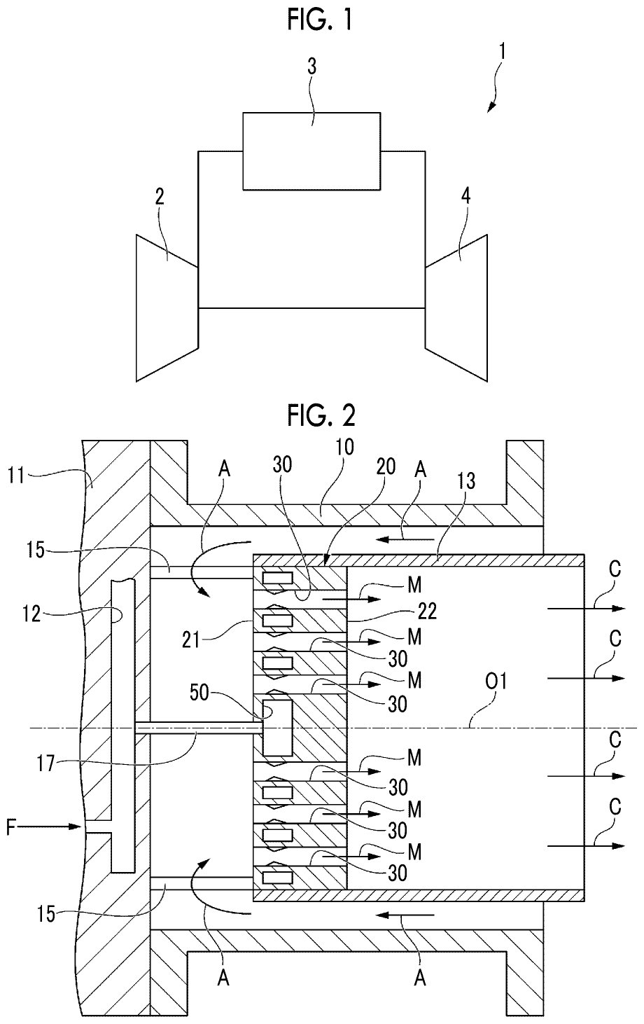

Hereinafter, a first embodiment of the present invention will be described in detail with reference to FIGS. 1 to 6.

As shown in FIG. 1, a gas turbine 1 according to the present embodiment has a compressor 2 that compresses air A, a combustor 3 that generates a combustion gas C, and a turbine 4 that is driven with the combustion gas C.

A plurality of the combustors 3 are provided at intervals in a circumferential direction nearby a rotary shaft of the gas turbine 1. The combustor 3 mixes fuel F with the air A compressed by the compressor 2 to combust the mixture and generates a high-temperature and high-pressure combustion gas C.

### [Combustor]

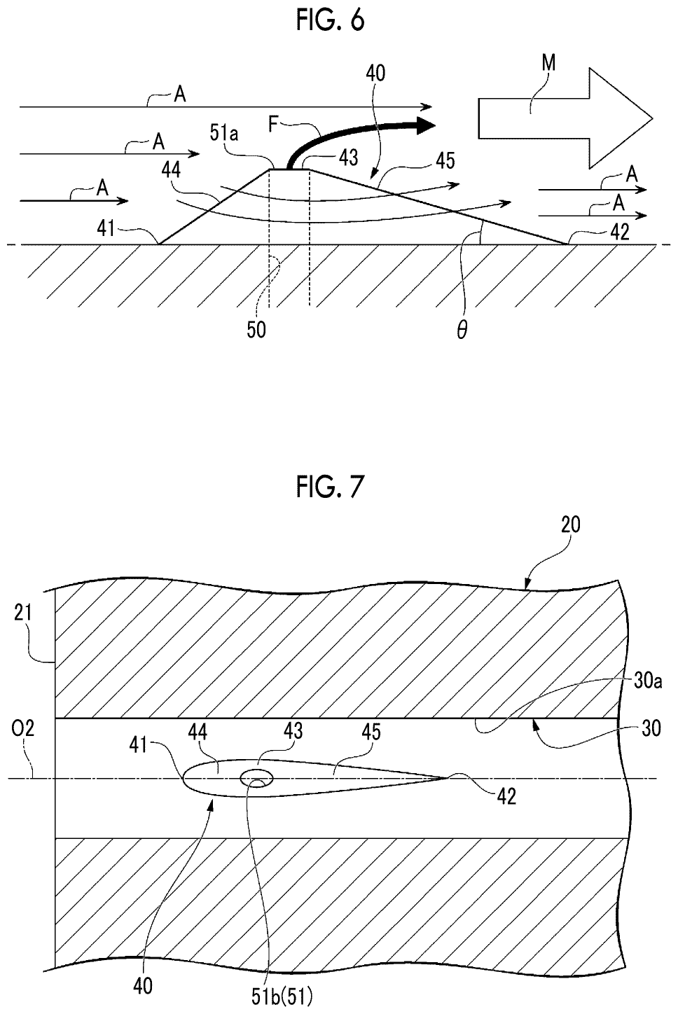

Hereinafter, a configuration of the combustor 3 will be described with reference to FIGS. 2 and 6.

As shown in FIG. 2, the combustor 3 includes an outer cylinder 10, an end cover 11, an inner cylinder 13, a supporting section 15, a fuel supply tube 17, and a combustor plate 20.

### [Outer Cylinder]

A cylindrical body has a cylindrical shape about a combustor axis O1 (hereinafter, simply referred to as an axis O1) which is a center of the combustor 3.

### [End Cover]

The end cover 11 has a disk shape that closes an end portion of the outer cylinder 10 on one side (left side in FIG. 2) in a direction of the axis O1. The end portion of the outer cylinder 10 on the one side in the direction of the axis O1 is brought into contact with the end cover 11. A fuel header 12 as a space is formed inside the end cover 11. The fuel F is supplied to the fuel header 12 from an outside. As the fuel F, hydrogen or a mixed fuel of the hydrogen and natural gas is used.

### [Inner Cylinder]

The inner cylinder 13 is disposed coaxially inside the outer cylinder 10. The inner cylinder 13 has a cylindrical shape extending in the direction of the axis O1 inside the outer cylinder 10. An end portion of the inner cylinder 13 on the one side in the direction of the axis O1 is separated from the end cover 11 in the direction of the axis O1. An outer diameter of the inner cylinder 13 is smaller than an inner diameter of the outer cylinder 10. Accordingly, an annular flow path is formed between an outer peripheral surface of the inner cylinder 13 and an inner peripheral surface of the outer cylinder 10. The air A compressed by the compressor 2 flows in the flow path from the other side (right side in FIG. 2) in the direction of the axis O1 to the one side in the direction of the axis O1.

### [Supporting Section]

The supporting section 15 is a member extending in the direction of the axis O1, and a plurality of the supporting sections 15 are provided at intervals in the circumferential direction. An end portion of the supporting section 15 on the one side in the direction of the axis O1 is fixed to a surface of the end cover 11 facing the other side in the direction of the axis O1 on an inner peripheral side of the outer cylinder 10. When the air A flowing to the one side in the direction of the axis O1 between the outer cylinder 10 and the inner cylinder 13 passes between the supporting sections 15 adjacent to each other, a flow direction is inverted to the other side in the direction of the axis O1.

### [Fuel Supply Tube]

The fuel supply tube 17 is a tubular member extending along the axis O1, and an end portion on the one side in the direction of the axis O1 is fixed to the end cover 11. The fuel supply tube 17 communicates with an inside of the fuel header 12 in the end cover 11 on the one side in the direction of the axis O1. The fuel F is introduced into the fuel supply tube 17 from the fuel header 12.

### [Combustor Plate]

The combustor plate 20 has a disk shape about the axis O1. The combustor plate 20 is provided to be fitted coaxially inside the inner cylinder 13. The combustor plate 20 has an upstream end surface 21 and a downstream end surface 22.

### [Upstream End Surface]

The upstream end surface 21 is an end surface of the combustor plate 20 facing the one side in the direction of the axis O1, and has a planar shape orthogonal to the axis O1. The upstream end surface 21 is disposed at the same position in the direction of the axis O1 as an end surface of the inner cylinder 13 on the one side in the direction of the axis O1.

### [Downstream End Surface]

The downstream end surface 22 is an end surface of the combustor plate 20 facing the other side in the direction of the axis O1, and has a planar shape orthogonal to the axis O1. The downstream end surface 22 is positioned on the one side in the direction of the axis O1 with respect to an end surface of the inner cylinder 13 on the other side in the direction of the axis O1. In this manner, a space is partitioned and formed by an inner peripheral surface of the inner cylinder 13 and the downstream end surface 22 of the combustor plate 20. The space is a combustion space of the combustor 3.

### [Mixing Tube]

The combustor plate 20 is provided with a plurality of mixing tubes 30 that extend in the direction of the axis O1 to penetrate across the upstream end surface 21 and the downstream end surface 22. An inside of the mixing tube 30 is a flow path in which the one side in the direction of the axis O1 is an upstream side and the other side in the direction of the axis O1 is a downstream side.

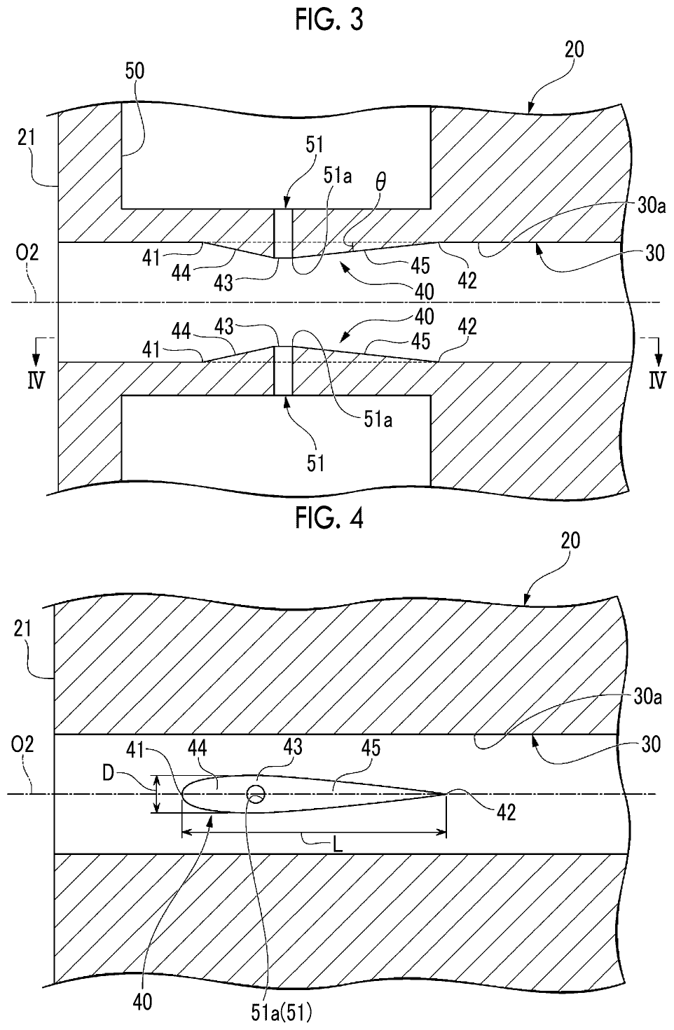

As shown in FIGS. 3 to 5, the mixing tube 30 has an inner wall surface 30a that extends linearly and that has a uniform inner diameter over the direction of the axis O1. A central axis O2 of the inner wall surface 30a is parallel to the axis O1. In any cross section including the central axis O2, the central axis O2 and the inner wall surface 30a are parallel to each other. A plurality of such mixing tubes 30 are provided to be aligned at intervals.

### [Bump Section]

As shown in FIGS. 3 to 5, a bump section 40 that protrudes to rise from the inner wall surface 30a of the mixing tube 30 is formed in the mixing tube 30. The bump section 40 is formed at a position closer to the upstream end surface 21 than to the downstream end surface 22 in the mixing tube 30. The bump section 40 is provided closer to the upstream end surface 21 side than to a center of the mixing tube 30 in an extending direction. A plurality of (two in the present embodiment) the bump sections 40 are provided at intervals in a circumferential direction of the mixing tube 30. The plurality of bump sections 40 are provided at equal intervals in the circumferential direction.

As shown in FIG. 4, the bump section 40 has a contour shape when viewed from a radial direction of the mixing tube 30, the contour shape forming a streamlined shape extending in a direction of the central axis O2. An end portion of the bump section 40 on the upstream side is a leading edge 41. An end portion of the bump section 40 on the downstream side is a trailing edge 42. The contour shape of the bump section 40 when viewed from the radial direction of the mixing tube 30 has a shape in which a width that is an interval in the circumferential direction increases from the leading edge 41 toward a trailing edge 42 side and decreases further toward the trailing edge 42 side and which reaches the trailing edge 42.

Here, in a case where a length of the contour shape of the bump section 40 in the direction of the central axis O2 when viewed from the radial direction of the mixing tube 30 (clearance between the leading edge 41 and the trailing edge 42) is denoted as L and a maximum width of the contour shape in the circumferential direction of the mixing tube 30 is denoted as D, a relationship 4≤L/D≤100 is established.

In particular, in the present embodiment, L and D of any cylindrical cross-sectional shape of the bump section 40 around the central axis of the mixing tube 30 satisfy the above-described relationship. An upper limit value of L/D is preferably 30, more preferably set to 20, and optimally set to 10.

As shown in FIG. 3, the bump section 40 has a mountain shape when viewed from the circumferential direction. That is, the bump section 40 has a contour shape that extends to be separated from the inner wall surface 30a from the leading edge 41 toward the trailing edge 42 side (toward a radial inner side of the mixing tube 30) when viewed in a longitudinal cross section including the leading edge 41, the trailing edge 42, and the central axis O2 and then extends to approach the inner wall surface 30a further toward the downstream side (toward a radial outer side of the mixing tube 30) to reach the trailing edge 42. That is, the bump section 40 has an upstream-side inclined surface 44 that forms a rising gradient for the air A flowing through the mixing tube 30, and a downstream-side inclined surface 45 that is positioned on a downstream side of the upstream-side inclined surface 44 and that forms a falling gradient for the air A flowing through the mixing tube 30, when viewed in the above-described longitudinal cross section. The upstream-side inclined surface 44 and the downstream-side inclined surface 45 are inclined with respect to the inner wall surface 30a, respectively.

An inclination angle (angle formed by the central axis O2 and the upstream-side inclined surface 44) of the upstream-side inclined surface 44 with respect to the inner wall surface 30a is larger than an inclination angle θ (angle formed by the central axis O2 and the downstream-side inclined surface 45) of the downstream-side inclined surface 45 with respect to the inner wall surface 30a. That is, a gradient of the upstream-side inclined surface 44 is steeper than that of the downstream-side inclined surface 45. For example, the inclination angle θ of the downstream-side inclined surface 45 with respect to the inner wall surface 30a is set in a range of 0°<θ≤8°.

A section between the upstream-side inclined surface 44 and the downstream-side inclined surface 45 is a top section 43 of the bump section 40. The top section 43 of the bump section 40 is a section of the bump section 40 that is positioned on a most radial inner side of the mixing tube 30. The top sections 43 of the plurality of bump sections 40 are separated from each other without coming into contact with each other.

Here, the upstream-side inclined surface 44 and the downstream-side inclined surface 45 may have a linear shape or a curved shape when viewed in the longitudinal cross section, respectively. In a case where the upstream-side inclined surface 44 and the downstream-side inclined surface 45 have a curved shape, the inclination angle of the upstream-side inclined surface 44 and the inclination angle θ of the downstream-side inclined surface 45 mean a maximum angle (maximum inclination), respectively.

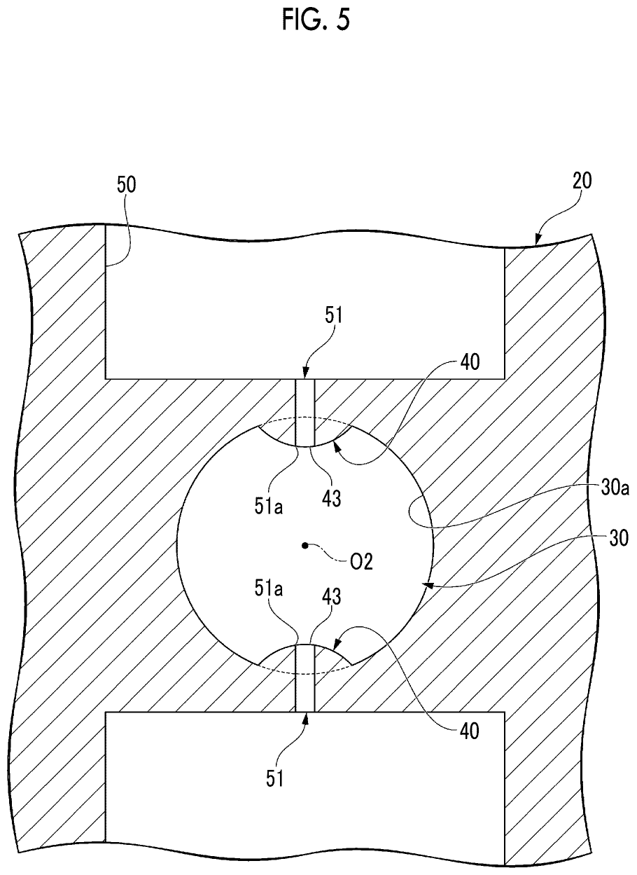

As shown in FIG. 5, the bump section 40 has a contour shape when viewed from the direction of the central axis O2 of the mixing tube 30, the contour shape forming a mountain shape. That is, when viewed in the direction of the central axis O2, the contour shape of the bump section 40 has a shape in which a dimension in a width direction, which is a dimension in the circumferential direction, decreases toward the radial inner side. Even when viewed from the direction of the central axis O2, the section of the bump section 40 on the most radial inner side is the top section 43, as in the case of the mixing tube 30 being viewed in the circumferential direction.

Such a bump section 40 has a structure in which a plurality of unit airfoils forming an airfoil along the inner wall surface 30a of the mixing tube 30 when viewed in the radial direction of the mixing tube 30 are laminated in the radial direction. The unit airfoils are formed in a shape that is one size smaller in a similar shape than the unit airfoils closer to the radial inner side.

A surface shape of the bump section 40 may be formed of a large number of flat surfaces or may have a convex curved surface shape. In addition, a surface shape in which a flat surface and a convex curved surface are combined with each other may be formed.

### [Plenum]

As shown in FIGS. 2 and 3, a plenum 50, which is a space formed to avoid the mixing tube 30, is formed inside the combustor plate 20. The plenum 50 is isolated from the flow path of the mixing tube 30 via a wall forming the inner wall surface 30a of the mixing tube 30. An end portion of the fuel supply tube 17 on the other side in the direction of the axis O1 is fixed to the combustor plate 20. The other side of the fuel supply tube 17 in the direction of the axis O1 communicates with an inside of the plenum 50. Accordingly, the fuel F is supplied into the plenum 50 via the fuel supply tube 17.

### [Fuel Injection Hole]

As shown in FIGS. 3 to 5, a fuel injection hole 51 causes the inside of the plenum 50 and the flow path in the mixing tube 30 to communicate with each other. The fuel injection hole 51 of the present embodiment extends in a direction orthogonal to the central axis O2 to be along the radial direction of the mixing tube 30. The fuel injection hole 51 has an end portion on the radial outer side of the mixing tube 30 that is open to the plenum 50, and an end portion on the radial inner side of the mixing tube 30 that is open to the flow path in the mixing tube 30. A plurality of (two in the present embodiment) the fuel injection holes 51 are provided for each mixing tube 30 at intervals in the circumferential direction of the mixing tube 30.

Here, an opening section 51a of the fuel injection hole 51 on a mixing tube 30 side is open on the surface of the bump section 40. In particular, in the present embodiment, the fuel injection hole 51 is open at the top section 43 of the bump section 40. Accordingly, the opening section 51a of the fuel injection hole 51 is positioned, with respect to the inner wall surface 30a of the mixing tube 30, on the radial inner side of the mixing tube 30.

### [Effects of Operation]

Next, operations and effects of operation of the combustor 3 according to the present embodiment will be described.

During an operation of the gas turbine 1, the air A flows inside each mixing tube 30, and the fuel F is injected into the mixing tube 30 from the opening section 51a of the fuel injection hole 51 in the mixing tube 30. The fuel F injected into the mixing tube 30 is mixed with the air A flowing inside the mixing tube 30, and thus a mixed gas M is generated. The mixed gas M is jetted and ignited to a further downstream side from the downstream end surface 22 of the combustor plate 20. In this manner, a flame is formed to correspond to each of the mixing tubes 30, and the generated combustion gas C is sent to the turbine 4.

Here, in the present embodiment, specifically, as shown in FIG. 6, the fuel F is injected from the opening section 51a formed on the surface of the bump section 40. Therefore, the fuel F is mixed with the air A on the radial inner side of the mixing tube 30. That is, the mixed gas M generated by mixing the air A and the fuel F flows toward the downstream side at a position separated from the inner wall surface 30a of the mixing tube 30.

In a case where the bump section 40 does not have a streamlined shape, the air A hits the bump section 40 and the flow is disturbed, and as a result, a vortex occurs on the downstream side of the bump section 40. In this case, the injected fuel F is disturbed by the vortex and is diffused, and as a result, a fuel concentration in a vicinity of the inner wall surface 30a of the mixing tube 30 is increased. As a result, there is a concern that flashback in which the flame flows back along the inner wall surface 30a may be induced.

In contrast, in the present embodiment, since the bump section 40 has a streamlined shape, the above-described problem can be avoided. That is, the air A that has reached the bump section 40 out of the air A flowing inside the mixing tube 30 smoothly flows around the bump section 40 toward the downstream side along the streamlined shape of the bump section 40. Therefore, the occurrence of the vortex can be suppressed, and accordingly, it is possible to prevent the fuel F from diffusing and reaching the inner wall surface 30a. That is, an increase in fuel concentration in the vicinity of the inner wall surface 30a can be reduced.

Further, on the downstream side of the bump section 40, a layer of the flow along the inner wall surface 30a is formed by the air A passing through the bump section 40. Therefore, the fuel F or the mixed gas M flowing through the section of the flow path in the mixing tube 30 on the radial inner side and the inner wall surface 30a can be divided by the layer of the air A. Accordingly, it is possible to even further reduce an increase in fuel concentration in the vicinity of the inner wall surface 30a.

In particular, according to the present embodiment, even in a case where hydrogen is used as the fuel F, or even in a case where a flow rate of the fuel F immediately after a fuel injection is started or at a low load is small and a penetration distance is short, it is possible to prevent flashback.

In addition, since the bump section 40 has a mountain shape when viewed from both the circumferential direction and the direction of the central axis O2 of the mixing tube 30, the air A can flow more smoothly around the bump section 40. Since the opening section 51a of the fuel injection hole 51 is formed at the top section 43 of the bump section 40, the fuel F can be supplied to a position farther from the inner wall surface 30a. Accordingly, it is possible to even further reduce an increase in fuel concentration in the vicinity of the inner wall surface 30a.

Further, in the present embodiment, the inclination angle θ of the downstream-side inclined surface 45 is set in a range of 0°<θ≤8°. Accordingly, it is possible to even further prevent the air A from being separated at a section of the bump section 40 on the downstream side. As a result, the disturbance of the flow on the downstream side of the bump section 40 can be suppressed, and the layer of the flow of the air A can be appropriately formed on the downstream side of the bump section 40. Therefore, the occurrence of flashback can be further prevented.

In a case where the length of the bump section 40 in the direction of the central axis O2 is denoted as L and the maximum width of the bump section 40 is denoted as D, a relationship 4≤L/D≤100 is established, that is, an aspect ratio of the contour shape of the bump section 40 is appropriately set. The upper limit value of L/D is preferably set to 30, more preferably set to 20, and optimally set to 10. Therefore, a pressure loss when the air A passes through the bump section 40 can be suppressed, and the disturbance of the flow on the downstream side of the bump section 40 can be even further suppressed.

### Second Embodiment

Next, a second embodiment will be described with reference to FIG. 7. In the second embodiment, the same reference numerals will be assigned to configuration elements which are the same as those according to the first embodiment, and detailed description thereof will be omitted.

In the second embodiment, an opening shape of the fuel injection hole 51 on the mixing tube 30 side is different from that in the first embodiment. That is, in the second embodiment, an opening of the fuel injection hole 51 on the surface of the bump section 40 is an elliptical opening section 51b.

The elliptical opening section 51b has an elliptical shape in which the direction of the central axis O2 of the mixing tube 30 is a major axis and the circumferential direction of the mixing tube 30 is a minor axis, when viewed from the radial inner side of the mixing tube 30.

Accordingly, a trajectory of a jet of the fuel F when viewed from the direction of the central axis O2 of the mixing tube 30 has a shape thinner than that in the first embodiment. That is, since a projected area of the jet in a flow direction of the air A can be reduced, the pressure loss of the air A can be reduced, and interference between the air A and the fuel F can be suppressed. Accordingly, the fuel F or the mixed gas M is prevented from diffusing to the inner wall surface 30a of the mixing tube 30, and an increase in fuel concentration in the vicinity of the inner wall surface 30a can be reduced. In particular, in a case of the fuel F in which flashback is likely to occur, it is preferable to adopt the elliptical opening section 51b.

### Third Embodiment

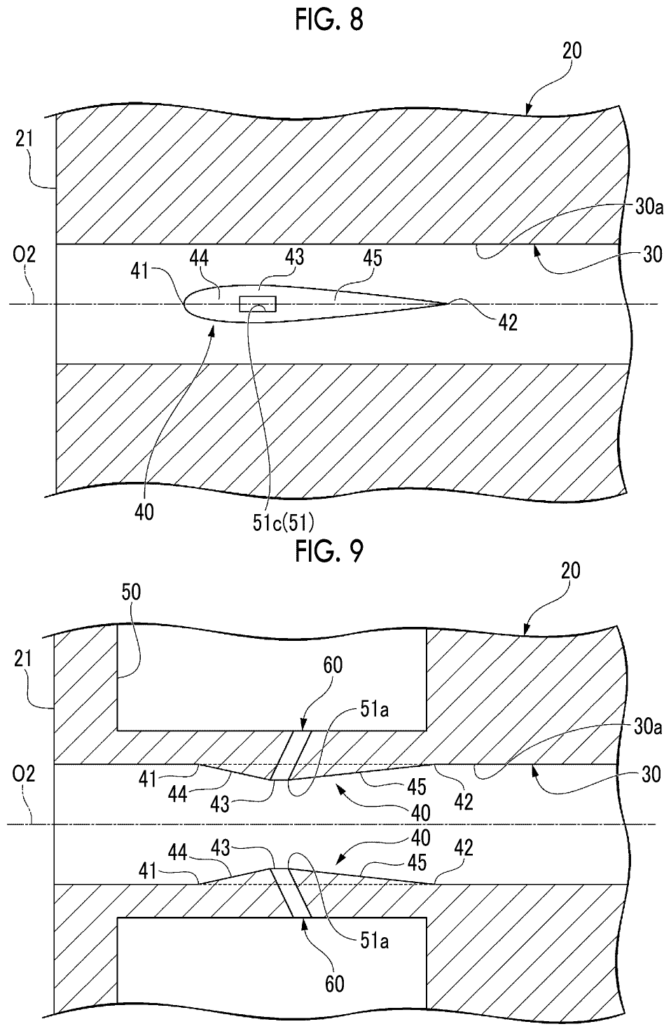

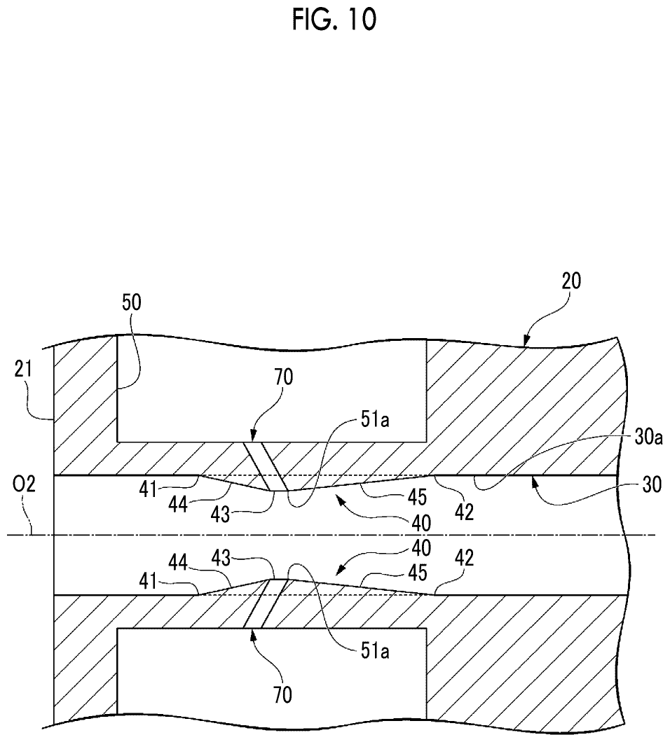

Next, a third embodiment will be described with reference to FIG. 8. In the third embodiment, the same reference numerals will be assigned to the configuration elements which are the same as those according to other embodiments, and detailed description thereof will be omitted.

In the third embodiment, the opening shape of the fuel injection hole 51 on the mixing tube 30 side is different from those in the first and second embodiments. That is, in the third embodiment, an opening of the fuel injection hole 51 on the surface of the bump section 40 is a rectangular opening section 51c.

The rectangular opening section 51c has a rectangular shape in which the direction of the central axis O2 of the mixing tube 30 is a longitudinal direction and the circumferential direction of the mixing tube 30 is a lateral direction, when viewed from the radial inner side of the mixing tube 30.

The longitudinal direction and the lateral direction of the rectangular opening section 51c may be any direction. That is, for example, the longitudinal direction may be the circumferential direction and the lateral direction may be the direction of the central axis O2, or the longitudinal direction and the lateral direction may be other directions.

Accordingly, the jet of the fuel F has a rectangular shape, so that the interference between the fuel F and the air A is promoted, and a wake can occur on the downstream side. As a result, the mixing of the fuel F and the air A can be promoted. As described above, since the layer of the flow of the air A along the inner wall surface 30a of the mixing tube 30 is formed on the downstream side of the bump section 40, the fuel F or the mixed gas M is also prevented from reaching the inner wall surface 30a.

Therefore, it is possible to reduce NOx by promoting the mixing of the fuel F and the air A while preventing flashback. In particular, in a case of the fuel F in which flashback is relatively unlikely to occur, the rectangular opening section 51c may be adopted.

### Fourth Embodiment

Next, a fourth embodiment will be described with reference to FIG. 9. In the fourth embodiment, the same reference numerals will be assigned to the configuration elements which are the same as those according to other embodiments, and detailed description thereof will be omitted.

The fourth embodiment is different from the first embodiment in terms of a configuration of a fuel injection hole 60. That is, the fuel injection hole 60 of the fourth embodiment extends toward the upstream side (upstream end surface 21 side) from the plenum 50 toward the radial inner side of the mixing tube 30. That is, the fuel injection hole 60 is configured to be inclined toward the upstream side.

Accordingly, the interference between the fuel F injected from the opening section 51a of the fuel injection hole 60 and the air A flowing through the mixing tube 30 is intensified, and the mixing of the fuel F and the air A is promoted. As a result, NOx can be reduced. In particular, in a case of the fuel F in which flashback is relatively unlikely to occur, the fuel injection hole 60 of the fourth embodiment may be adopted.

### Fifth Embodiment

Next, a fifth embodiment will be described with reference to FIG. 10. In the fifth embodiment, the same reference numerals will be assigned to the configuration elements which are the same as those according to other embodiments, and detailed description thereof will be omitted.

The fifth embodiment is different from the first embodiment in terms of a configuration of a fuel injection hole 70. That is, the fuel injection hole 70 of the fifth embodiment extends toward the downstream side (downstream end surface 22 side) from the plenum 50 toward the radial inner side of the mixing tube 30. That is, the fuel injection hole 70 is configured to be inclined toward the downstream side.

In this manner, the interference between the fuel F injected from the opening section 51a of the fuel injection hole 70 and the air A flowing through the mixing tube 30 is suppressed, and it is possible to prevent the fuel F or the mixed gas M from reaching the inner wall surface 30a of the mixing tube 30. Therefore, the occurrence of flashback can be even further prevented. In particular, in a case of the fuel F in which flashback is likely to occur, it is preferable to adopt the fuel injection hole 70 of the fifth embodiment.

### Sixth Embodiment

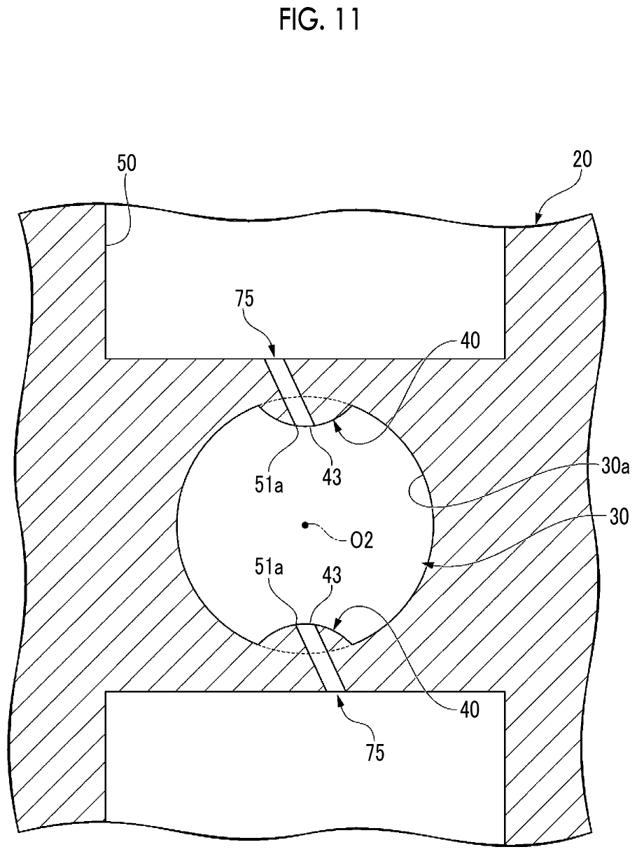

Next, a sixth embodiment will be described with reference to FIG. 11. In the sixth embodiment, the same reference numerals will be assigned to the configuration elements which are the same as those according to other embodiments, and detailed description thereof will be omitted.

The sixth embodiment is different from the first embodiment in terms of a configuration of a fuel injection hole 75. That is, the fuel injection hole 75 of the sixth embodiment extends in the circumferential direction of the mixing tube 30 from the plenum 50 toward the radial inner side of the mixing tube 30. That is, the fuel injection hole 75 is configured to be inclined in the circumferential direction. In a case where there are a plurality of the fuel injection holes 75, inclination directions of the fuel injection holes 75 in the circumferential direction may be the same as each other or may be opposite to each other.

Accordingly, the interference between the fuel F injected from the opening section 51a of the fuel injection hole 75 and the air A flowing through the mixing tube 30 is intensified, and the mixing of the fuel F and the air A is promoted. As a result, NOx can be reduced.

### Seventh Embodiment

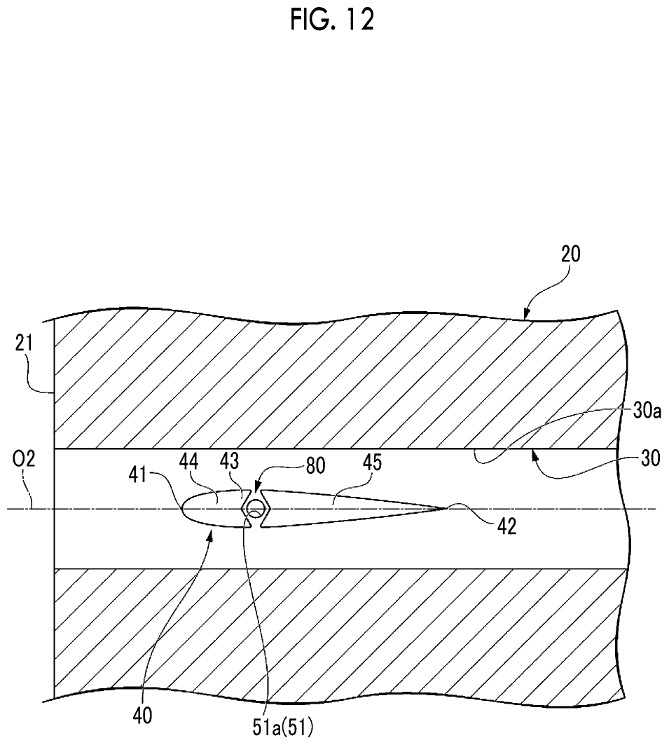

Next, a seventh embodiment will be described with reference to FIG. 12. In the seventh embodiment, the same reference numerals will be assigned to the configuration elements which are the same as those according to other embodiments, and detailed description thereof will be omitted.

In the seventh embodiment, a slit 80 is formed in the bump section 40. The slit 80 is formed to cut the bump section 40 in the circumferential direction, and thus the bump section 40 is divided in the direction of the central axis O2. The slit 80 is formed at a position of the fuel injection hole 51 in the direction of the axis O1. Therefore, the slit 80 exposes the fuel injection hole 51 in the circumferential direction of the mixing tube 30.

Even with such a structure of the bump section 40, it is possible to prevent flashback as in the first embodiment.

### OTHER EMBODIMENTS

Although the embodiments of the present invention have been described hereinbefore, the present invention is not limited thereto and can undergo some changes as appropriate without departing from the technical scope of the invention.

For example, in the embodiment, the bump section 40 has a mountain shape when viewed from both the circumferential direction and the direction of the central axis O2 of the mixing tube 30. However, the present invention is not limited thereto. For example, the bump section 40 may have an angular shape such as a rectangular shape when viewed from at least one of the circumferential direction and the direction of the central axis O2 of the mixing tube 30. Even in that case, when the shape of the bump section 40 when viewed in the radial direction of the mixing tube 30 is a streamlined shape, the air A flows to smoothly avoid the bump section 40. Therefore, the flow of the air A along the inner wall surface 30a can be formed on the downstream side of the bump section 40. Therefore, it is possible to prevent the fuel For the mixed gas M from reaching the inner wall surface 30a of the mixing tube 30.

For example, the fuel injection holes 51, 60, and 70 may extend in the circumferential direction toward the radial inner side of the mixing tube 30. In this case, as a result of the fuel F being jetted with a circumferential component of the mixing tube 30, a spiral flow can be formed, and the mixing of the air A and the fuel F can be promoted. Further, even in such a case, since the flow of the air A along the inner wall surface 30a of the mixing tube 30 is present, an increase in fuel concentration in the vicinity of the inner wall surface 30a can be reduced.

### [Supplementary Notes]

The combustor 3 and the gas turbine 1 described in each embodiment are understood, for example, as follows.
(1) A combustor 3 according to a first aspect includes a combustor plate 20 including an upstream end surface 21 and a downstream end surface 22 which are orthogonal to a combustor axis O1, a plurality of mixing tubes 30 which extend to penetrate across the upstream end surface 21 and the downstream end surface 22 and into which air A is introduced from an upstream end surface 21 side, a bump section 40 which is formed to rise from an inner wall surface 30a of the mixing tube 30 and which has a streamlined shape extending in a direction of a central axis O2 of the mixing tube 30 when viewed in a radial direction of the mixing tube 30, and a fuel injection hole 51 which has an opening section 51a, which is open in the bump section 40 and through which fuel F is injectable into the mixing tube 30.

The fuel F injected from the opening section 51a of the bump section 40 is mixed with the air A at a position separated from the inner wall surface 30a on the radial inner side. In addition, the air A smoothly flows around the bump section 40 along the streamlined shape of the bump section 40. Accordingly, a layer of the flow of the air A is formed between the mixed gas M and the inner wall surface 30a. As a result, it is possible to avoid an increase in fuel concentration of the mixed gas M on the inner wall surface 30a and to prevent flashback.
(2) A combustor 3 according to a second aspect is the combustor 3 according to the first aspect, in which the bump section 40 may have a mountain shape protruding to a radial inner side of the mixing tube 30 when viewed in both a circumferential direction of the mixing tube 30 and the direction of the central axis O2 of the mixing tube 30, and the opening section 51a may be open at a top section 43 of the mountain shape.

Accordingly, the air A can flow more smoothly around the bump section 40, and the fuel F can be injected into a position farther from the inner wall surface 30a.
(3) A combustor 3 according to a third aspect is the combustor 3 according to the second aspect, in which when viewed in a cross section including a leading edge 41 and a trailing edge 42 of the bump section 40, an inclination angle θ of a downstream-side inclined surface 45 from the trailing edge 42 to the top section 43 may be set in a range of 0°<θ≤8°.

As a result, the air A can be prevented from being separated from the bump section 40, and the layer of the flow of the air A can be appropriately formed on the downstream side of the bump section 40.
(4) A combustor 3 according to a fourth aspect is the combustor 3 according to any one of the first to third aspects, in which, in a case where a length in a cylindrical cross-sectional shape of the bump section 40, which is around the central axis O2 of the mixing tube 30, in the direction of the central axis O2 of the mixing tube 30 is denoted as L and a maximum width of the bump section 40 in a circumferential direction of the mixing tube 30 is denoted as D, a relationship 4≤L/D≤100 may be established.

Therefore, a pressure loss when the air A passes through the bump section 40 can be suppressed, and the disturbance of the flow on the downstream side of the bump section 40 can be suppressed.
(5) A combustor 3 according to a fifth aspect is the combustor 3 according to any one of the first to fourth aspects, in which the opening section 51a may have an elliptical shape with the direction of the central axis O2 of the mixing tube 30 as a major axis when viewed in the radial direction of the mixing tube 30.

In this manner, the interference between the air A and the fuel F can be suppressed, the diffusion of the fuel F can be suppressed, and the occurrence of flashback can be prevented.
(6) A combustor 3 according to a sixth aspect is the combustor 3 according to any one of the first to fourth aspects, in which the opening section 51a may have a rectangular shape when viewed in the radial direction of the mixing tube 30.

In this manner, the mixing of the air A and the fuel F can be promoted, and an occurrence of NOx can be suppressed.
(7) A combustor 3 according to a seventh aspect is the combustor 3 according to any one of the first to sixth aspects, in which the fuel injection hole 60 may extend toward the upstream end surface 21 side, going toward a radial inner side of the mixing tube 30.

In this manner, the mixing of the air A and the fuel F can be promoted, and an occurrence of NOx can be suppressed.
(8) A combustor 3 according to an eighth aspect is the combustor 3 according to any one of the first to sixth aspects, in which the fuel injection hole 70 may extend toward a downstream end surface 22 side, going toward a radial inner side of the mixing tube 30.

In this manner, the interference between the air A and the fuel F can be suppressed, the diffusion of the fuel F can be suppressed, and the occurrence of flashback can be prevented.
(9) A combustor 3 according to a ninth aspect is the combustor 3 according to any one of the first to eighth aspects, in which the fuel injection hole 75 may extend toward a circumferential direction of the mixing tube 30, going toward a radial inner side of the mixing tube 30.

In this manner, the mixing of the air A and the fuel F can be promoted, and an occurrence of NOx can be suppressed.
(10) A combustor 3 according to a tenth aspect is the combustor 3 according to any one of the first to ninth aspects, in which the bump section 40 may have a slit 80 that divides the bump section 40 in the direction of the central axis O2 and that exposes the fuel injection hole 51 in a circumferential direction of the mixing tube 30 in the bump section 40.

Even in this case, as described above, it is possible to avoid an increase in fuel concentration of the mixed gas M on the inner wall surface 30a and to prevent flashback.
(11) A gas turbine 1 according to an eleventh aspect is the gas turbine 1 including a compressor 2 that generates air A, the combustor 3 according to any one of the first to tenth aspects that generates a combustion gas C by combusting a mixed gas M generated by mixing fuel F with the air A compressed by the compressor 2, and a turbine 4 that is driven with the combustion gas C.

### REFERENCE SIGNS LIST

1: gas turbine
2: compressor
3: combustor
4: turbine
10: outer cylinder
11: end cover
12: fuel header
13: inner cylinder
15: supporting section
17: fuel supply tube
20: combustor plate
21: upstream end surface
22: downstream end surface
30: mixing tube
30a: inner wall surface
40: bump section
41: leading edge
42: trailing edge
43: top section
44: upstream-side inclined surface
45: downstream-side inclined surface
50: plenum
51: fuel injection bole
51a: opening section
51b: elliptical opening section
51c: rectangular opening section
60: fuel injection bole
70: fuel injection bole
75: fuel injection hole
80: slit
O1: combustor axis
O2: central axis
A: air
F: fuel
M: mixed gas
C: combustion gas
θ: inclination angle

1. A combustor comprising:
a combustor plate including
an upstream end surface and a downstream end surface which are orthogonal to a combustor axis,
a plurality of mixing tubes which extend to penetrate across the upstream end surface and the downstream end surface and into which air is introduced from an upstream end surface side,
a bump section which is formed to rise from an inner wall surface of the mixing tube and which has a streamlined shape extending in a direction of a central axis of the mixing tube when viewed in a radial direction of the mixing tube, and
a fuel injection hole which has an opening section, which is open in the bump section and through which fuel is injectable into the mixing tube.

2. The combustor according to claim 1,
wherein the bump section has a mountain shape protruding to a radial inner side of the mixing tube when viewed in both a circumferential direction of the mixing tube and the direction of the central axis of the mixing tube, and
the opening section is open at a top section of the mountain shape.

3. The combustor according to claim 2,
wherein when viewed in a cross section including a leading edge and a trailing edge of the bump section, an inclination angle of a downstream-side inclined surface from the trailing edge to the top section is set in a range of 0°<θ≤8°.

4. The combustor according to claim 1,
wherein, in a case where a length in a cylindrical cross-sectional shape of the bump section, which is around the central axis of the mixing tube, in the direction of the central axis of the mixing tube is denoted as L and a maximum width of the bump section in a circumferential direction of the mixing tube is denoted as D, a relationship 4≤L/D≤100 is established.

5. The combustor according to claim 1,
wherein the opening section has an elliptical shape with the direction of the central axis of the mixing tube as a major axis when viewed in the radial direction of the mixing tube.

6. The combustor according to claim 1,
wherein the opening section has a rectangular shape when viewed in the radial direction of the mixing tube.

7. The combustor according to claim 1,
wherein the fuel injection hole extends toward the upstream end surface side, going toward a radial inner side of the mixing tube.

8. The combustor according to claim 1,
wherein the fuel injection hole extends toward a downstream end surface side, going toward a radial inner side of the mixing tube.

9. The combustor according to claim 1,
wherein the fuel injection hole extends toward a circumferential direction of the mixing tube, going toward a radial inner side of the mixing tube.

10. The combustor according to claim 1,
wherein the bump section has a slit that divides the bump section in the direction of the central axis and that exposes the fuel injection hole in a circumferential direction of the mixing tube in the bump section.

11. A gas turbine comprising:
a compressor that generates air;
the combustor according to claim 1 that generates a combustion gas by combusting a mixed gas generated by mixing fuel with the air compressed by the compressor; and
a turbine that is driven with the combustion gas.
